(19) United States
(12) Patent Application Publication
(10) Pub. No.: US 2012/0173309 A1
(43) Pub. Date: Jul. 5, 2012

(54) Residual Value Bidding System

(76) Inventor: E. Buckley Barlow, South Jordan, UT (US)

(21) Appl. No.: 13/314,044

(22) Filed: Dec. 7, 2011

Related U.S. Application Data
(60) Provisional application No. 61/421,166, filed on Dec. 8, 2010.

(51) Int. Cl. G06Q 30/08; G06Q 30/02

(52) U.S. Cl. 705/14.1; 705/26.3

(57) ABSTRACT

A sponsor provides items to a residual value bidding system, which allows an auction to auction the items to bidders. Value expended to bid on the item, such as through a pay-per-bid model may be returned as a giftcard to the sponsor's store. Incentives may be used to encourage bidding, such as a coupon that gains value as more bids are placed. The coupons may be time dated to encourage immediate redemption. Sponsored auctions may also be limited to geography or demographics.

### RELATED APPLICATIONS

The present application claims the benefit of U.S. Provisional Application Ser. No. 61/421,166, filed Dec. 8, 2010, which is incorporated herein in its entirety.

### THE FIELD OF THE INVENTION

The present invention relates to auctions. More specifically, the present invention relates to a residual value bidding system.

### BACKGROUND

Auction systems are part of entertainment shopping. They provide customer excitement on bidding for various products, hoping for a great deal. Yet, that excitement can lead to disappointment, when the customer does not win the auction. This disappointment can be even stronger, when a pay-per-bid model is used.

Businesses are sensitive to people's brand experiences. Thus, a business may be reluctant to associate their brands with negative experiences. This may include the current model of auctions, especially pay-per-bid auctions where money is spent on each bid.

However, auctions, especially online penny auctions may be a source of buzz and excitement for brands. A sponsorship of an auction may benefit both the brand awareness, as well as the auction. Yet it is the negative experience that provides an obstacle between the brand and the auction.

Thus, there is a need to generate the buzz of an auction for a brand without the disappointment.

### SUMMARY OF THE INVENTION

It is an object of the present invention to provide an improved residual value bidding system.

According to one aspect of the invention, a sponsor may place an item up for bid on a pay-for-bid auction. At the end of the auction, a portion of the value of the bids, up to the full value, may be returned as a giftcard for the purchase of merchandise at the sponsor's store.

According to another aspect of the invention, for every bid placed on an item, a benefit, such as a percentage off coupon, may increase. The benefit may also be time-limited. This benefit and time-limiting may encourage bidding on items as well as traffic to the sponsor's store.

These and other aspects of the present invention are realized in an improved residual value bidding system as shown and described in the following figures and related description.

### BRIEF DESCRIPTION OF THE DRAWINGS

Various embodiments of the present invention are shown and described in reference to the numbered drawings wherein:

FIG. 1 shows a diagram of a residual value bidding system;

FIG. 2 shows a flowchart of a residual value bidding system;

FIG. 3 shows a flowchart of a residual value bidding system with bidding rewards;

FIG. 4 shows a system overview diagram of a residual value bidding system;

FIG. 5 shows a system diagram of a residual value bidding system;

FIG. 6A shows a residual value bidding memory module diagram;

FIG. 6B shows a residual value bidding module mock-up;

FIG. 7 shows a mock-up of a modular bidding site with residual value bidding system;

FIG. 8 shows a screenshot of a modular bidding site with residual value bidding system; and

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

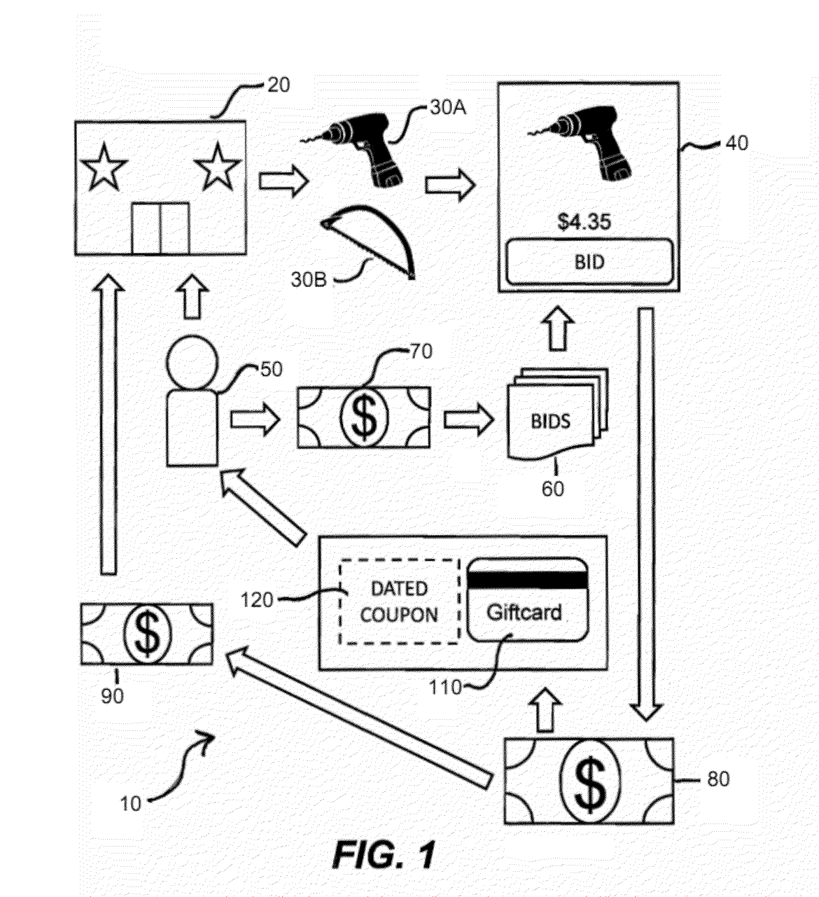

In FIGS. 1 to 8, a sponsor of an auction may return some or all of the value spent in bidding to bidders. Bidding may be encouraged by providing more rewards for bidders that use more bids. For example, in one embodiment, a sponsor may return a giftcard for the value of the bids placed on an online penny auction. Bidders may be encouraged to bid because they may receive a percentage off coupon that increases for every bid placed on an item.

The income from the bids may be divided among the auction and the sponsor. Thus, a sponsor may create a consumer buzz while maintaining the fun of an auction with a positive brand experience. Furthermore, the sponsor may ensure that the bidder's money must be spent in their store by the return of the value through giftcards. In fact, the percentage off bonus may be time limited to further encourage immediate recognition and use of the incoming money.

As both parties may be paid through the purchase of bids, the auction site may not require a cost to promote the sponsored auction. Thus, the sponsor may receive advertising and promotion for the cost of a few items to bid upon and the split of the revenue in terms of the giftcards.

Turning now to FIG. 1, a diagram of a residual value bidding system 10 is shown. A sponsor 20 provides items 30A, 30B to place up for auction 40. A bidder 50 purchases bids 60 for value 70. The bidder 50 may bid upon the item 30A with the purchased bids 60. If the bidder 50 wins the auction 40, the bidder may receive the item 30A after paying the winning price 80. A portion of the proceeds 90 may be split between the sponsor 20 and the auction owner. The sponsor 20 may return at least a portion of the value of the bids placed by a bidder 50, which may be in the form of a giftcard 110. Incentives to bid may also be used, which may include time-dated coupons 120 that grow a percentage off purchases at the sponsor 20 as more bids are placed. The bidder 50 may then use the value received, such as a giftcard 110 and/or a time-dated coupon 120 to shop at the sponsor 20.

The amount of the value returned and incentive may be determined by the sponsor. For example, a giftcard 110 may be sent to bidder 50 for a portion or all of the value of the bids 60 spent. The value of the giftcard 110 may be preferably between 50% and 100% of the value of the bids 60 spent, but more preferably 100% of the value of the bids 60 spent.

Similarly, an incentive, such as a coupon may be used to drive bids. The coupon may increase in value for each bid on an item. In some embodiments, the incentive may reset at the end of each auction. The bidder 50 may then receive the highest incentive earned during the sponsorship period. The incentive may be delivered electronically or in physical form and limited to a time period. This limit may include being dated for a specific period of time, such as two days, to encourage quick redemption, for a minimum purchase and/or for a maximum purchase. The incentive range may be adjusted in light of the profit margin at the sponsor store. For example, a discount starting at 2% and ending at 20% may be appropriate for a sponsor with a profit margin above 20%. The coupon may also be exclusive, such that only the coupon or the giftcard may be used.

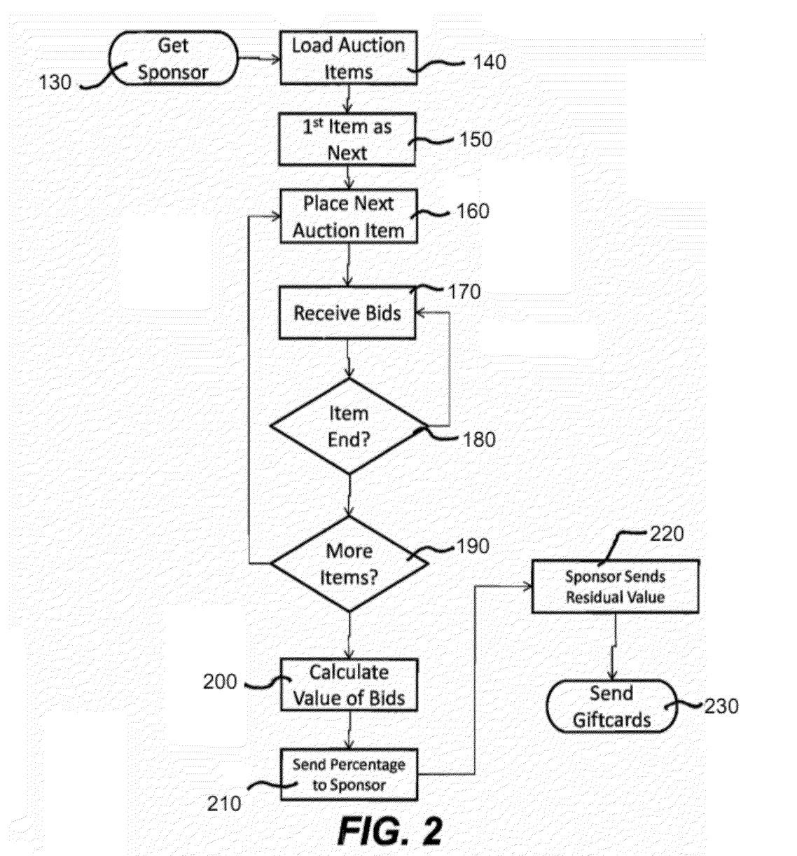

Turning to FIG. 2, a flowchart of a residual value bidding system is shown. Once a sponsor has been obtained 130, their sponsored items may be loaded into the auction system 140. The first item is loaded 150 and placed up for auction 160. Bids are taken 170 until the item listing ends 180. If there are more items to auction 190, then another item is placed up for auction 160. Otherwise, the value of the bids is calculated 200. A portion of the value of the bids may be returned to the sponsor 210. The sponsor may then send a portion of the bid value to each bidder 220, such as giftcards 230.

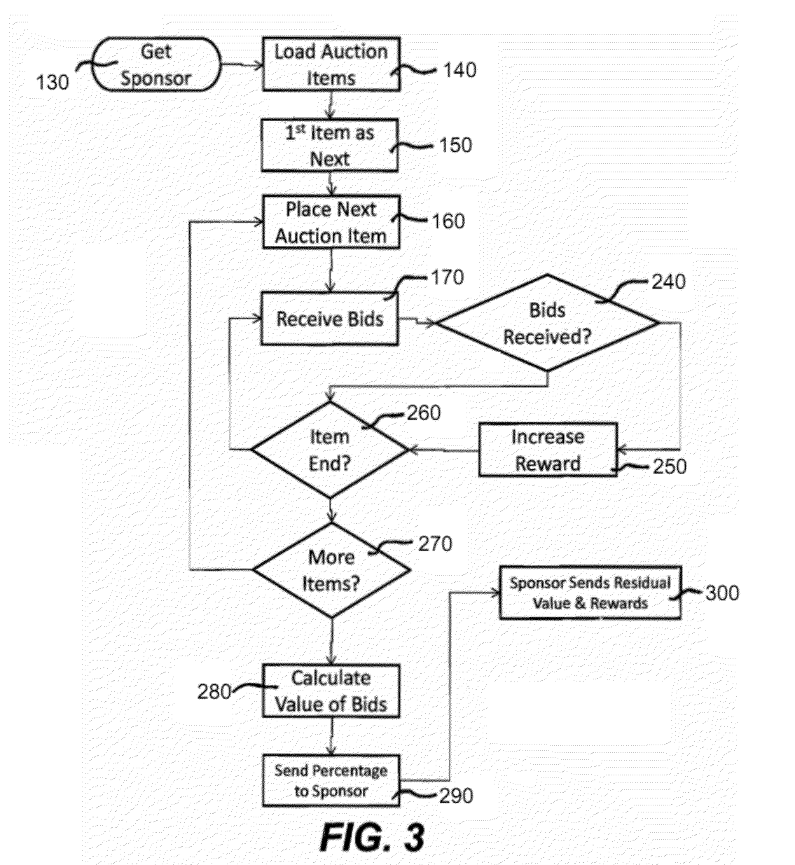

Turning to FIG. 3, a flowchart of a residual value bidding system with bidding rewards is shown. Similar to FIG. 2, a sponsor may be found 130 with items to be loaded into the auction system 140. The first item is placed in the queue for next 150, thus placed up for auction as next 160 and bids are taken 170. If bids are received 240, then the incentive may be increased 250. If not, then a check may be made to see if the item's auction has ended 260. If not, more bids may be taken 170. If the item's auction has ended 260, then if more items are available for auction 270, the next item may be auctioned 160. If no more items are available 270, the value of bids may be calculated 280 and the sponsor's share of the bid value be paid 290. The residual value of the bids and the incentive may then be awarded to the bidders 300, such as by a giftcard and coupon.

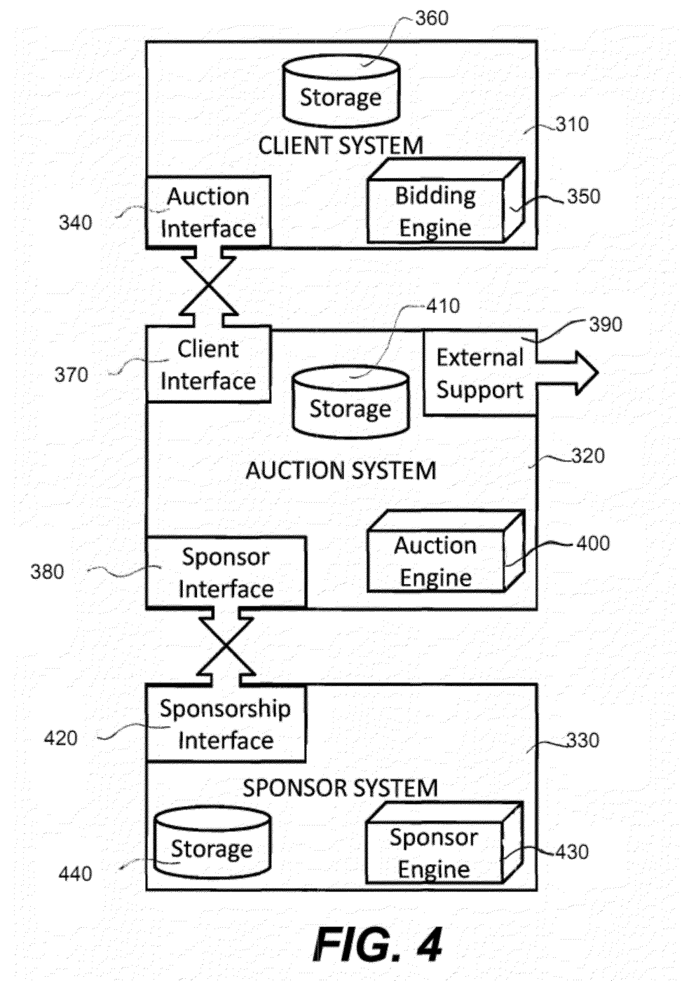

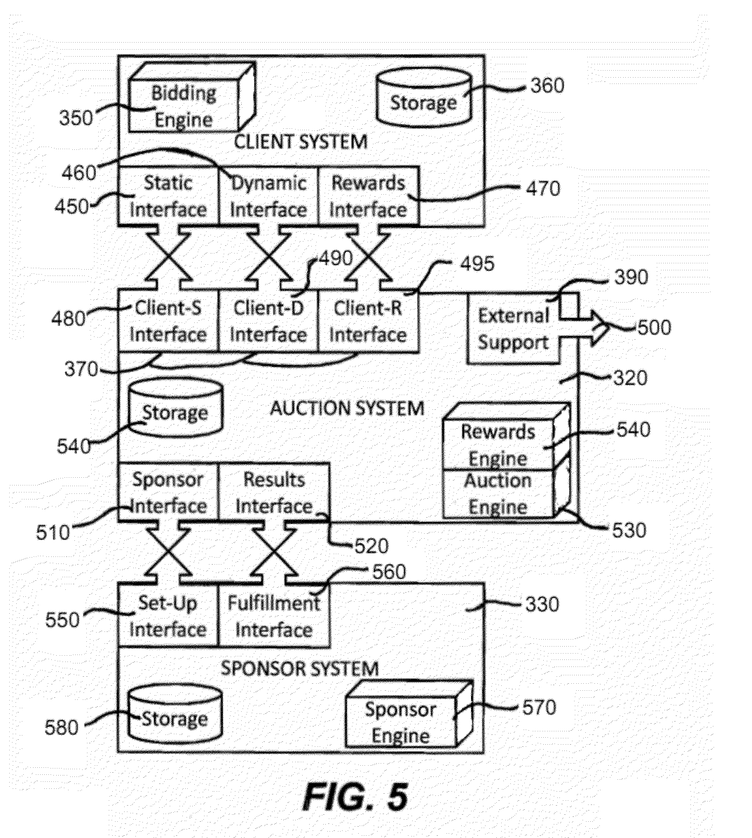

Turning to FIGS. 4 and 5, a system diagram of a residual value bidding system is shown. The residual value bidding system may contain one or more client systems 310, an auction system 320 and one or more sponsor systems 330. Each system may involve a single computer, such as a PC, a server, etc., or be hosted using cloud computing, etc. Each system may have storage for keeping data, interfaces for communicating with external systems and engines or processors for processing data and making decisions. FIG. 4 shows more of an overview of system components, while FIG. 5 shows a more specific embodiment.

In FIG. 4, a client system 310 may have an auction interface 340, a bidding engine 350 and storage 360. The auction interface 340 may organize communication between the client system 310 and the auction system 320. The auction interface 340 may allow the setup and continuing information flow relative to an auction. The bidding engine 350 may process information and make decisions based on current and stored information. The bidding engine 350 may thus enable timing and bidding in the asynchronous environment of the internet. Storage 360 may be used to pre-cache and retrieve history locally, which may free the communication link for the bidding process.

The auction system 320 may include a client interface 370, sponsor interface 380, external support interface 390, an auction engine 400 and storage 410. The client interface 370 may enable communication to the client system 310. The client interface 370 may send assets and auction information over predetermined or standard channels. The sponsor interface may enable communication with sponsor systems 330. The sponsor interface 420 may enable the sponsor to set up auctions and receive information about the auction status and redemption information. The external support interface 390 may communicate with external systems, such as to enable tasks to be offloaded from the auction system. The auction engine 400 may allow the auction system to process and make decisions relating to the auction system 320, including auction setup, timing and winners. The storage 410 may store information relating to the auction, such as information enabling auction history and fulfilling rewards.

The sponsor system 330 may include a sponsorship interface 420, sponsor engine 430 and storage 440. The sponsorship interface 420 may enable communication from the sponsor system 320 to the auction system 330. The sponsorship interface 420 may enable the sponsor to set up auctions and receive information about the auction status and redemption information. The sponsor engine 430 may process the sponsor's information and make decisions based on the current information and information in storage 440. Storage may store information relating to the sponsorship, including information caching and history.

Turning now to FIG. 5, a more specific discussion of an embodiment according to FIG. 4 is discussed. The auction interface 340 in FIG. 4 may be further separated into a static interface 450, dynamic interface 460 and rewards interface 470. The static interface 450 may be used to load more static information, such as a webpage and pictures. The static interface 450 may use technologies, such as html, to retrieve initial and/or large pieces of information. The dynamic interface 460 may be used to modify the static information, such as javascript may modify a webpage. The rewards interface 470 may facilitate the delivery of incentives and bid value to the client system. The rewards interface 470 may directly deliver the rewards to the end user, such as by an email to print out, a barcode on a mobile device to scan, or a code to input.

The bidding engine 350 may direct the operation of the client system. This may include client side software that makes the bidding system smooth. Thus, the bidding engine 350 may include abilities to cache and estimate auction expiration times. The bidding engine 350 may also store and display current incentives and/or incentives to beat based on past history.

The storage 360 may store current information and history for the bidder to review. The storage may cache pictures, bidding history, current benefits, or the maximum incentive achieved so far.

It should be recognized that the client system may be on a device that can display the auction to a user. This may include a mobile device, PC, smartphone, streaming display, remote access system or other system capable of interacting with the user.

An auction system 320 may have a client-s interface 480, a client-d interface 490, a client-r interface 495, an external support interface 500, a sponsor interface 510, a results interface 520, an auction engine 530 and storage 540. Similar to the client interfaces 450, 460, 470, the client-s (static) interface 480, client-d (dynamic) interface 490, client-r (results) interface 495, the auction system may send static information, dynamic information and rewards information.

The external support interface 500 may allow communication to external support systems. The external support systems may include login support, credit card processing, administrative interfaces, social media interfaces and other systems that would use an API (application programmer's interface), interactive manual input, and/or standard communication protocols to communicate with the auction system.

The auction system 320 may also communicate with the sponsor system 330 through a sponsor interface 510 and results interface 520. The sponsor interface 510 may allow the sponsor to set up auction items and parameters about the auction, including retail values, suggest time limits, descriptions, incentives and fulfillment options. The results interface 520 may allow the sponsor to receive information about the current and past status of the sponsored auctions.

This may include fulfillment information, such as amounts of giftcards, values of coupons, shipping information for the products, and confirmations of receipt. The fulfillment information may also include information about creating the giftcard and/or coupons electronically, including barcodes, serial numbers, activation, or other electronic information.

The auction system 320 may also include an auction engine 530 and a rewards engine 540. The auction engine 530 may process and run the sponsored auction. This may include deciding winners, processing bids, sending messages to clients and sponsors. The rewards engine 540 may process and run the redemptions of rewards earned in the auction. This may include electronically notifying winners, activating coupons and/or giftcards, and any changes in the rewards that may occur. The engines may store or retrieve current or historical information to/from storage, such as a database.

The sponsor system 330 may include a set-up interface 550, a fulfillment interface 560, a sponsor engine 570 and storage 580. The set-up interface 560 may allow the sponsor to prepare a sponsored auction, as described above. The fulfillment interface 560 may allow a sponsor to fulfill and check on auction status as described above. The sponsor engine may allow the sponsor system to automate, process and/or prepare information that would allow the sponsor to set-up or fulfill the sponsored auction. The storage 580 may store current and/or historical information.

While the components have been shown to be within a single system, it should be recognized that the individual components may be merged and/or further separated into individual units. The components may also reside and/or communicate across several units.

These units may be physical devices, coding constructs, memory use, objects or other modules or systems that work together to accomplish a similar goal.

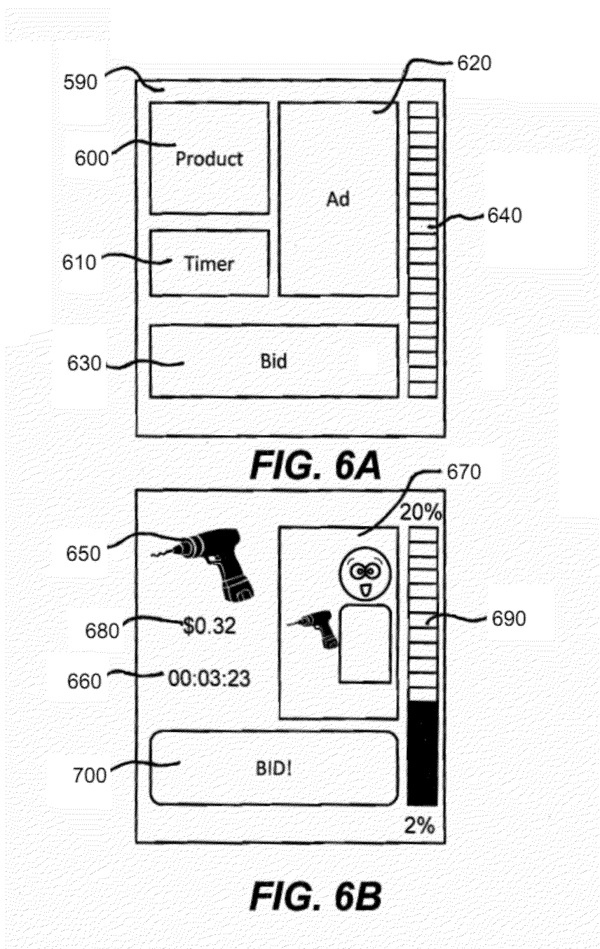

Turning to FIG. 6A, a residual value bidding module memory diagram is shown. A bidding module 590 may contain information relating to a sponsored auction. Here, the module contains a product 600, a timer 610, an advertisement 620, bid information 630 and incentive information 640. This information may be stored, such that it is available for the bidding system to process and display. The product 600 may contain pictures and/or information relating to the product up for auction. The timer 610 may contain the information about how much longer the auction may have to go. The advertisement 620 may contain information that the sponsor would like to show, such as brand and/or company information. Bid information 630 may contain current and/or historical bid information. Incentive information 640 may include the incentives earned by bidders for the number of bids placed. Thus the sponsored auction may be placed in a module that may be contained and stored in storage and/or memory.

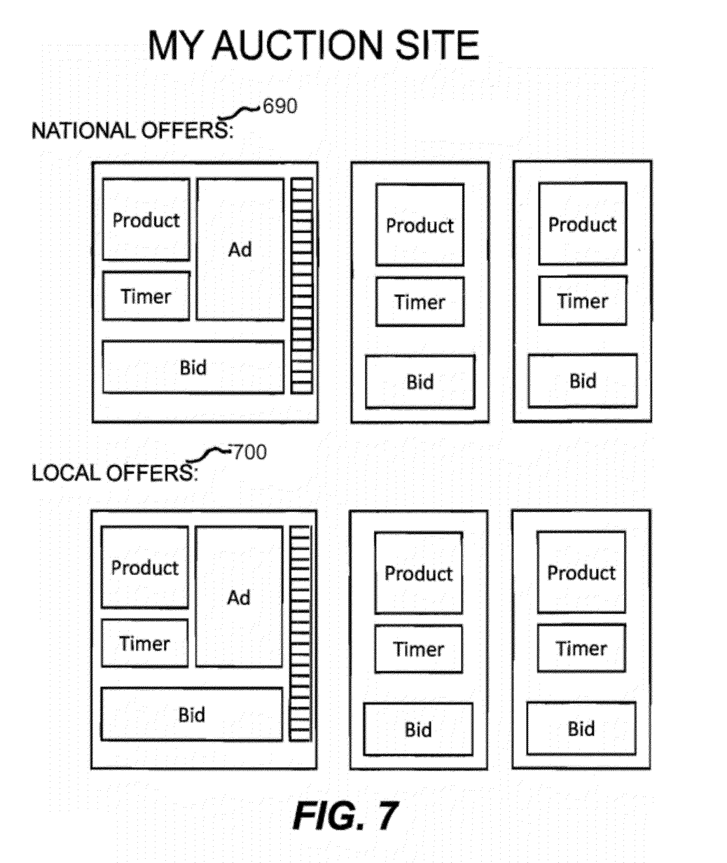

Turning to FIG. 6B, a residual value bidding module mock-up is shown. The website display may show the underlying information stored in FIG. 6A. The display may include a product 650, a timer 660, an advertisement 670, bid information 680 and incentive counter 690. As a bidder clicks on the bid box 700, the bid information 690 may be incremented as well as the timer 660. For every predetermined number of bids, the incentive counter 690 may be incremented to a maximum. The advertisement 670 may include multi-media information, such as pictures, text, video, flash and other multi-media. The advertisement 670 may also contain a link to the sponsor's website, causing traffic to visit the sponsor's website. As the sponsored auction may be modular, the system may replace one or more normal auctions with available sponsored auctions as seen in FIG. 7.

Turning to FIG. 7, a mock-up of a modular bidding site with residual value bidding system is shown. The sponsored auctions may include the option of localization. The localization may be based on geography (national 690 and local 700 are shown in FIG. 7), but also by demographics. Thus, a sponsor may choose to limit sponsored auctions to relevant geographic or demographic limits. This may allow a sponsor to select a market segment that may use the residual value to come in to the store and purchase beyond the residual value given by the auction.

The localization may be determined by multiple factors. The localization may use the account information to identify geography and demographic information, and thus require a user to be logged in to see the sponsored auctions. The localization may also be accomplished through IP address, packet inspection and/or speed tests, thus identifying the source of the internet requests. Further, the identification may be combined, such as to confirm the geography and/or likely demographics of the individuals.

As the sponsored auction is modular, the system may replace normal auctions with sponsored auctions upon recognition of the localization information. Thus, the site may look similar, and only change when relevant sponsored auctions are available.

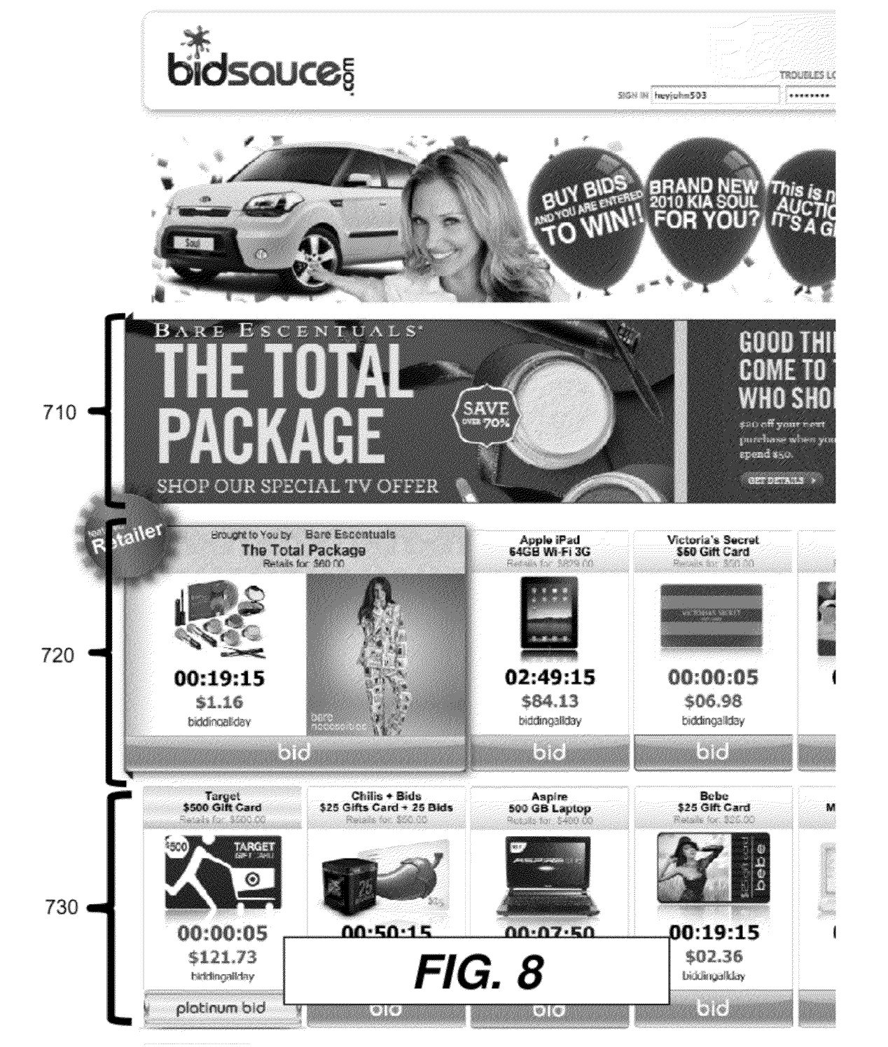

Turning to FIG. 8, a screenshot of a modular bidding site with residual value bidding system is shown. A sponsored auction may include a banner 710 and the sponsored auction module 720 on a website. Normal auctions 730 may continue alongside the sponsored auction.

There is thus disclosed an improved residual value bidding system. It will be appreciated that numerous changes may be made to the present invention without departing from the scope of the claims.

What is claimed is:

1. A residual value bidding system comprising:
a bidding system;
an auction system in communication with the bidding system and receiving bids from the bidding system;
a sponsor system in communication with the auction system; and
a residual value returned to a bidder using the bidding system, the residual value based on the value of bids used on the auction system.

2. The residual value bidding system of claim 1, wherein the bidding system comprises storage containing information about bids.

3. The residual value bidding system of claim 1, wherein the auction system comprises storage containing information about auctions conducted.

4. The residual value bidding system of claim 1, wherein the sponsor system comprises an interface for entering information about an auction directed by a sponsor.

5. The residual value bidding system of claim 1, wherein the system is programmed to track the value of bids used during an auction and assigns credits a giftcard with a value based on a portion of the value of the bids.

6. The residual value bidding system of claim 5, wherein the system is programmed to credit a giftcard to a retail outlet associated with a sponsor of the auction.

7. The residual value bidding system of claim 1, wherein the system is programmed to generate a percentage off coupon based on the number or value of bids made.

8. The process of returning residual value from an auction, the method comprising:
receiving bids from a bidder over a computer system;
determining the value of bids placed by the bidder;
calculating an amount to be returned to the bidder based on the value of bids; and
returning the amount to the bidder.

9. The process of claim 8, wherein the computer system determines the value of to be returned to the bidder and credits a giftcard with the value.

10. The process of claim 9, wherein the system associates the bids with a sponsored auction and credits a giftcard associated with the sponsor.

11. The process of claim 8, wherein the computer system generates a discount coupon in response to the value or number of bids made.

12. The process of returning residual value from an auction, the method comprising:
selecting a sponsor;
receiving information about one or more items for auction from the sponsor;
receiving bids from a bidder over a system on one of the one or more items;
determining the value of bids placed by the bidder; and
returning an amount to the bidder based on the value of bids.

13. The process of claim 12, wherein the process comprises the system calculating the amount to be returned and credits a giftcard provided to the bidder.

14. The process of claim 12, wherein the process comprises the system calculating the amount to be returned and creating a coupon based on the number or value of bids made.
